(19) United States
(12) Patent Application Publication
(10) Pub. No.: US 2026/0277857 A1
(43) Pub. Date: Sep. 17, 2026

(54) MATTER LEDGER SYSTEM

(71) Applicant: Broughton Partners, Savannah, GA (US)

(72) Inventor: Cason Carter, Savannah, GA (US)

(21) Appl. No.: 19/450,378

(22) Filed: Jan. 15, 2026

Related U.S. Application Data
(60) Provisional application No. 63/771,843, filed on Mar. 14, 2025.

(51) Int. Cl. G06F 16/16; G06F 16/176; G06Q 50/18

(52) U.S. Cl. CPC G06F 16/168; G06F 16/176; G06Q 50/18

(57) ABSTRACT

A case management system and operation thereof are provided. The case management system includes a portal, where the portal receives a plurality of case files, each case file including identifying data and permitted users associated with the case files. The portal creates and stores a case record for each case file. The portal receives a case update information related to the case file from one or more of the permitted users, identifies the case update information with at least one case record based on a selected certainty of an association of the identifying data included with the case update information, and categorizes the received case update information with the identified at least one case record. A user interface in communication with the portal then enable a user to select one or more parameters relating one or more case records for compiling a customized case analysis.

### CROSS-REFERENCE TO RELATED APPLICATION

The present application claims the benefit of U.S. Provisional Patent Application No. 63/771,843, filed on Mar. 14, 2025.

### INCORPORATION BY REFERENCE

The disclosure of U.S. Provisional Patent Application No. 63/771,843, filed on Mar. 14, 2025, is hereby incorporated by reference for all purposes as if set forth in its entirety.

### TECHNICAL FIELD

The present disclosure generally relates to systems and methods for management of litigation; and, in particular to systems and methods for associating and managing firms to manage shared matters including one or more of case data, issues, status updates, client information, and other case data for various litigation matters and providing controlled access thereto.

### BACKGROUND

Litigation may involve one or more of case referrals, co-counsel, lenders, and other parties on the plaintiff’s side with different roles to play. Some cases involve thousands of plaintiffs referred from different parties with one or more litigating firms handling the case. The referral firm and the litigating firm need to stay in contact to handle the individual plaintiff’s case and ensure case details are passed back and forth reliably. It is imperative in large litigation matters that the documents, requests, and payment is handled between the co-counsels efficiently to not only prevent miscommunication but also uphold the attorney’s ethical duties. The firms must stay in constant communication. Further, a referral firm may have multiple referral cases with multiple litigating firms covering different matters. Tracking the delivery and execution of retainers for originating, referral, and litigating firms can be a challenge.

Furthermore, a litigating firm may maintain its own case management system to manage a matter’s case files, including documents from the plaintiff such as medical records and retainers. When a referral firm works with a litigating firm, the litigating firm needs to request documents from the referral firm or co-counsel that has the relationship with the plaintiff. The request may be done by email, letter or other communication that requires an individual communication between the co-counsels. This can introduce inefficiencies and issues tracking what actions have been done, and, if these request are not completed, certain attorney’s fees and damages may not be paid out to the referral or litigating firm. Moreover, privacy issues regarding personal identifying information and protected health information may arise through unsecure means of sharing information. Thus, there is a need for effective communication between the parties with automatic updates, requests, and status verification while maintaining privacy for managing complex litigation.

### BRIEF DESCRIPTION

Aspects and advantages of the disclosure will be set forth in part in the following description, or may be obvious from the description, or may be learned through practice of the invention.

In one aspect, the disclosure includes a case management system. The case management system includes: a portal comprising a processor and a memory operably coupled to the processor and having computer-readable instructions stored thereon that, when executed by the processor, cause portal to: receive an initial plurality of case files, each of the case files including identifying data and one or more permitted users associated with one or more of the case files; create and store a case record for each case file, including the identifying data and permitted users; receive a case update information related to the case file from one or more of the permitted users; identifying the case update information with at least one case record based on a selected certainty of an association of the identifying data included with the case update information; and categorizing the received case update information with the identified at least one case record, including determining a status of the case record; and a user interface configured to enable a user to select one or more parameters relating one or more case records for compiling a customized case analysis.

In another aspect, the disclosure includes a method for operating a case management system. The case management system includes a portal and a user interface, and the method includes: receiving an initial plurality of case files, each of the case files including identifying data and one or more permitted users associated with one or more of the case files; creating and storing a case record for each case file, including the identifying data and permitted users; receiving a case update information related to the case file from one or more of the permitted users; identifying the case update information with at least one case record based on a selected certainty of an association of the identifying data included with the case update information; categorizing the received case update information with the identified at least one case record, including determining a status of the case record; and receiving a user input of a selection one or more parameters relating to one or more case records for compiling a customized case analysis.

In another aspect, the disclosure includes a non-transitory machine-readable medium having executable instructions to cause one or more processing units to perform a method for operating a case management system. The case management system includes a portal and a user interface, and the method comprising: receiving an initial plurality of case files, each of the case files including identifying data and one or more permitted users associated with one or more of the case files; creating and storing a case record for each case file, including the identifying data and permitted users; receiving a case update information related to the case file from one or more of the permitted users; identifying the case update information with at least one case record based on a selected certainty of an association of the identifying data included with the case update information; categorizing the received case update information with the identified at least one case record, including determining a status of the case record; and receiving a user input of a selection one or more parameters relating to one or more case records for compiling a customized case analysis.

Still other aspects, embodiments, and advantages of the case management systems and methods are provided by the present disclosure, including exemplary aspects and embodiments thereof, which are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE FIGURES

A more particular description will be rendered by reference to specific embodiments thereof that are illustrated in the accompanying drawings, which are incorporated in and constitute a part of this specification. The accompanying drawings, together with the detailed description, are included to explain and provide a further understanding of the exemplary embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure. Understanding that these drawings depict only typical embodiments thereof and are not therefore to be considered to be limiting of its scope, exemplary embodiments will be described and explained with additional specificity and detail through the use of the accompanying drawings in which:

FIG. 1 illustrates a partner portal system, according to exemplary embodiments;

FIGS. 2A-E illustrate pages of user interface of a partner portal system, according to exemplary embodiments;

FIGS. 3A-D illustrate pages of user interface of a partner portal system, according to exemplary embodiments;

FIG. 4 illustrates exemplary aspects of a computing system according to one or more embodiments described hereby;

FIG. 5 illustrates exemplary aspects of a communications architecture according to one or more embodiments described hereby; and

FIG. 6 illustrates an example workflow for a partner portal system, according to exemplary embodiments.

Various features, aspects, and advantages of the embodiments will become more apparent from the following detailed description, along with the accompanying figures in which like numerals represent like components throughout the figures and text. The various described features are not necessarily drawn to scale but are drawn to emphasize specific features relevant to some embodiments.

### DETAILED DESCRIPTION

Reference will now be made in detail to various embodiments of the present disclosure, which is directed to a case management system and methods of managing multiple litigation matters, including, but not limited to, litigation matters related to one or more plaintiffs, defendants, counsel, litigation funders, joint defense arrangements and/or groups. Each example is provided by way of explanation and is not meant as a limitation and does not constitute a definition of all possible embodiments. It will be understood that the following Detailed Description in combination with the Figures is provided to assist in understanding the embodiments and principles disclosed herein, and those skilled in the art will recognize that this example is illustrative and not limiting and is provided purely for explanatory purposes and should not be interpreted as a limitation on the scope or applicability thereof.

In addition, it will be understood by those skilled in the art that while the embodiments discussed herein are related to a case management system and related methods of managing litigation, the case management system and methods can be used for management of data relating to other matters, such as, for example, management of portfolios of real property, loans and/or credit application and lines, Intellectual Property assets, and various other files/portfolios, and to enable secure (e.g., in embodiments, providing different levels or secure access for different parties, entities and/or persons) and easy remote access to such data by users.

Litigation, including individual cases and larger sets of cases such as class actions and cases involving similar claims brought by one or more plaintiffs against one or more defendants, may involve multiple different firms representing each party or one or more related parties. For example, a referral firm may be interested in mass torts litigation. To move forward with a mass torts and/or a class action, a large number of plaintiffs (or “clients”) must be found with a legitimate claim. The referral firm may contract with an originating firm to advertise to the public to find the clients.

The originating firm may have a website, call center, etc., to gather potential client’s information. The originating firm may then screen clients for a legitimate claim and deliver signed retainers to the referral firm. For example, an originating firm may be an advertising agency or entity that a client first contacts to pursue a claim for some type of injury (e.g., a personal or physical injury, business injury such as a breach of contract, or other claim).

Once one or more clients are found by the originating firm, the referral firm may then refer a client’s case to a litigating firm. The litigating firm may have more specialized expertise in handling the client’s type of case. In this case, the litigating firm also can be considered a handling firm.

In some cases, the referral firm and litigating firm can be co-counsel, both handling and/or managing the litigation to various degrees. In some embodiments, the originating firm and the referral firm are the same entity. In other embodiments, the referral firm and litigating firm are the same.

Some cases may further involve a lender, “litigation funder,” or other party that can provide funding for a party, such as providing monetary support to plaintiffs during a case in exchange for a percentage of the settlement or judgement the plaintiff receives.

In other cases, one or more insurance companies can be involved. For example, in embodiments, a defendant can have insurance against a claim for liability.

Each of the described parties, the originating firm, referral firm, litigating firm, lenders, litigation funders, insurance companies, and potentially other parties, have an interest in conducting the litigation and, for the firms, an ethical duty to their client in the management and conduct of the litigation. Each party will want to ensure the proper agreement, and each party may need to share information on the plaintiff to advance the case. Further, each of these parties may sign a retainer, co-counsel agreement, and/or a referral agreement that needs to be executed for the case to move forward.

A portal of effectuating status updates, request, progress, and identifying gaps in information will better assist each party in meeting the client’s needs and satisfying each party’s ethical duties to the plaintiff. Through the portal, the need for reporting emails is eliminated. The portal allows for simultaneous case updates to and from several discrete parties. For example, if a litigating firm requires more information for a case file, such as a medical record, a request may be made in the portal. The request may then be automatically shared with the originating firm and the referral firm. In another example, the portal automatically pulls data from each firm. When a litigating firm’s case status changes, each party is notified.

What was once a three-step process — (1) the originating firm finding a client; (2) delivering the client to the referral firm; and (3) the referral firm sending the retainer to counsel in the litigating firm — is now a seamless, one-step process facilitated by the portal, where a single case record can be updated by any of the permitted parties.

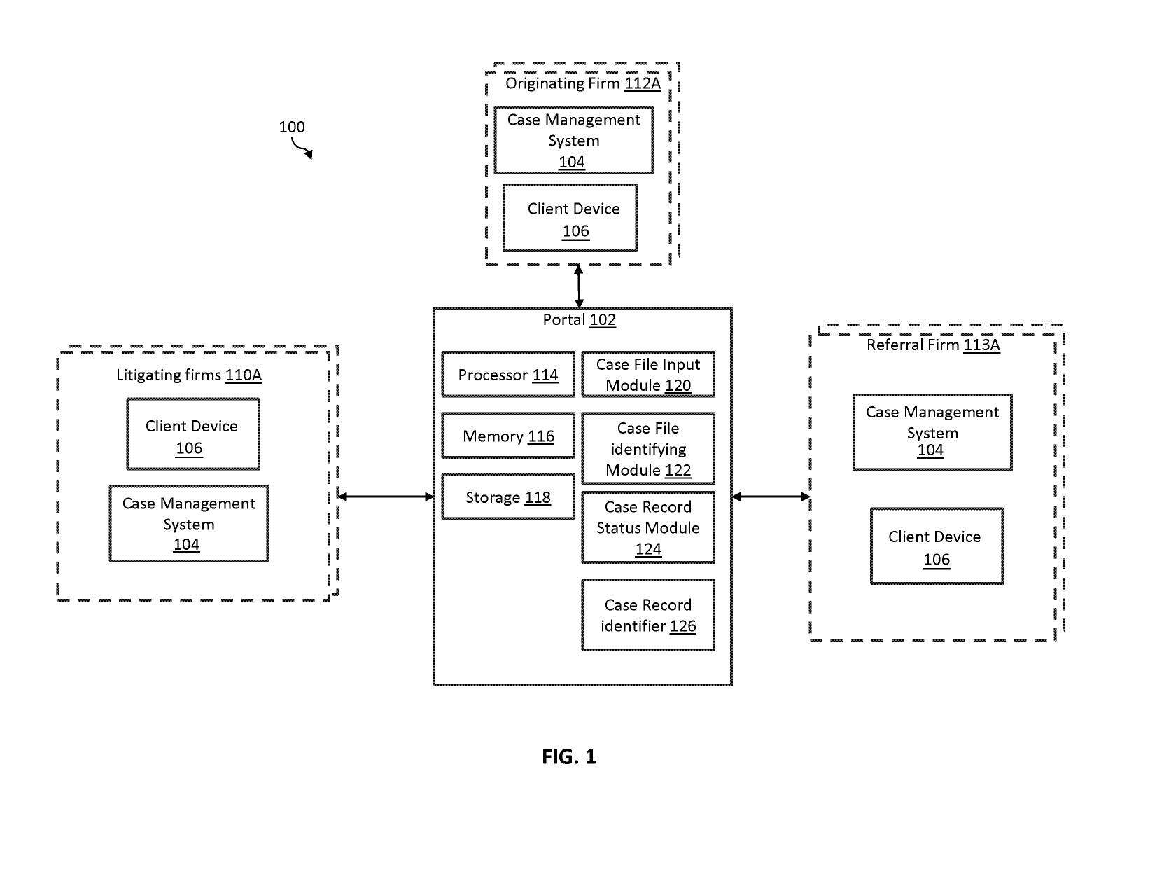

Turning to FIG. 1, an example partner portal system 100 is illustrated, according to embodiments herein. The partner portal system 100 includes a portal 102 which may be in communication with a case management system 104.

The case management system 104 may be in communication with a client device 106. There may be multiple client devices 106 in communication with one case management system 104. Further, there may be multiple case management systems 104 in communication with the portal 102. The client devices 106 may be any internet connected device for logging into the portal 102. The client device 106 may connect to the case management system 104. The client device 106 may further connect directly to the portal 102.

As shown in FIG. 1, a litigating firm 110 may include the case management system 104 and one or more client devices 106. There may be multiple litigating firms 110, e.g., 110A to 110N, in communication with the portal 102. Each of the litigating firms 110 may include their own unique login and communication preferences with the portal 102 for uploading case files.

Similarly, there may be one or more originating firms 112, e.g., 112Ato 112N, connected to the portal 102. Each originating firm 112 includes their own unique login and communication preferences with the portal 102. In some examples, each of the originating firms 112 also include their own case management system 104 in communication with the portal 102 for uploading case files.

There may also be one or more referral firms 113, e.g., 113Ato 113N, connected to the portal 102. Each referral firm 113 includes their own unique login and communication preferences with the portal 102. In some examples, each of the referral firms 113 also include their own case management system 104 in communication with the portal 102 for uploading case files.

To further describe the relationship between the firms, the originating firm 112 may be in contract with the referral firm 113 for an order to advertise to the public and identify clients who may have tort claims. The members of the public then contact the originating firm 112 in response to the advertisements or marketing by the originating firm 112. The originating firm 112 then vets the potential client for a valid tort claim. The originating firm 112 may send the case file, potentially including a retainer, to the referral firm 113 through the portal 102 once the potential clients are approved. Therefore, the originating firm 112 may fill the order for a certain number of retainers ordered by the referral firm 113.

The relationship between the originating firm 112 and the referral firm 113 may be included in the order data on the portal 102. The order data may set out the number of clients for a specific tort type requested by the referral firm 113. In another example, the order data may be limited by budget, where each retainer delivered to the referral firm 113 by the originating firm 112 has an associated fee, and retainers are delivered by the originating firm 112 until the budget is exhausted.

The referral firm 113 or originating firm 112 may then share a case record in the portal 102 with a litigating firm to 110 to litigate the case. The litigating firm 110 may share status updates in the portal 102 regarding the litigation process for each case record. In other examples, a group of multiple originating firms 112 may be involved in the same case file, where the case record is shared with multiple firms, including multiple originating firms 112, as well as one or more ligating firms 110.

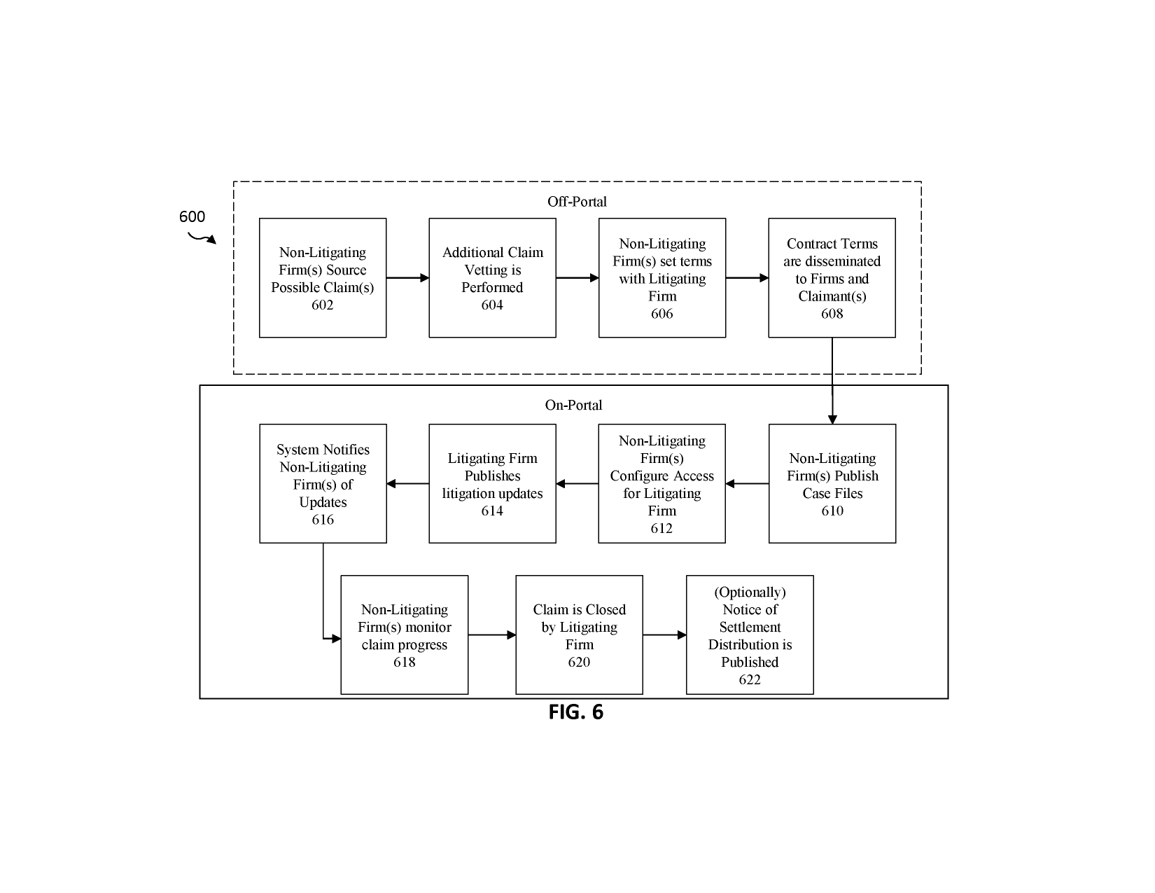

An example workflow of case file processing and order fulfillment is further described in relation to FIG. 6 below.

The portal 102 may include a processor 114 for executing instructions. The portal 102 may also include a memory 116 for storing data and instructions for the processor 114 to. The portal 102 may also include a storage 118 for storing case records, documents, login information, credentials, permission structures, and other data used by the portal 102.

A user may use the client devices 106 of the litigating firm 110, the originating firm 112, or the referral firm 113 to access the portal 102. The litigating firm 110, the originating firm 112, and/or the referral firm 113 may share information with the portal 102 as case files. Each case file represents the input data to the portal 102. In some examples, the case files are documents, emails, status updates, and/or spreadsheets.

The portal 102 may then match the case files to a case records. A case record represents the processed case file for a specific client. A case record may be identified by identifying data. The identifying data may tie a case record to a specific client party, e.g., the individual making the claim.

In some examples, the identifying data is a case identification (ID), a client’s personal information, or the client’s contact information.

Other identifying data may include the permitted users associated with the case file and subsequently the case record. A permitted user may include the specific the litigating firm 110, the originating firm 112, and/or the referral firm 113 responsible for the case record. A permitted user may also be limited specific users in the litigating firm 110, the originating firm 112, and/or the referral firm 113.

With the case records organized in the portal 102, the information in the case record may be shared across the different firms connected to the portal 102 to sync updates between the firms, provide status updates, fill in blank information, and/or issue tickets for missing information. This provides automatic communication, status checks, and efficient management of litigation, retainer delivery, order fulfillment, and document sharing while preserving privacy and security.

In some examples, the case management systems 104 may share case files with portal 102. The case management systems 104 may be included in each of the litigating firm 110, the originating firm 112, and/or the referral firm 113. These case files may be originating from the originating firm 112, for example, or they may be the litigating firm’s own cases. The litigating firm 110 may update the portal 102 with updating information by sharing case files in their case management system 104.

The case management system 104 and the portal 102 may communicate the case update information, including requests for information or status updates based on the update information.

Through the permissions structure between the case management system 104 and the portal 102, data may be automatically shared on a case in the portal 102 with the originating firm 112. The originating firm 112 can then view a case’s updates, progress, as a well as view any requests from the litigating firm 110 to the originating firm 112A.

The originating firm 112 may further upload case files to the portal 102 in response to requests by the litigating firm 110. The portal 102 may include a shared file function for secure upload and download between the litigating firm 110 and the originating firm 112.

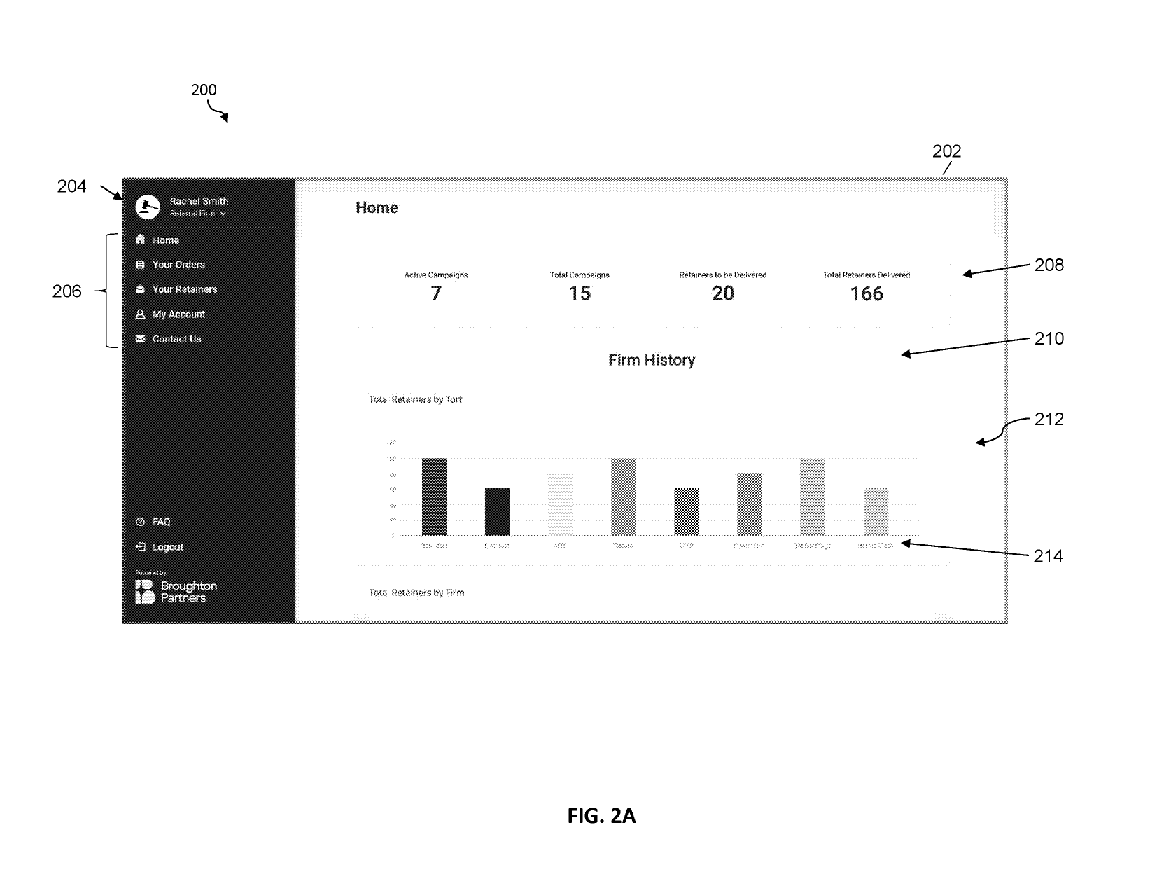

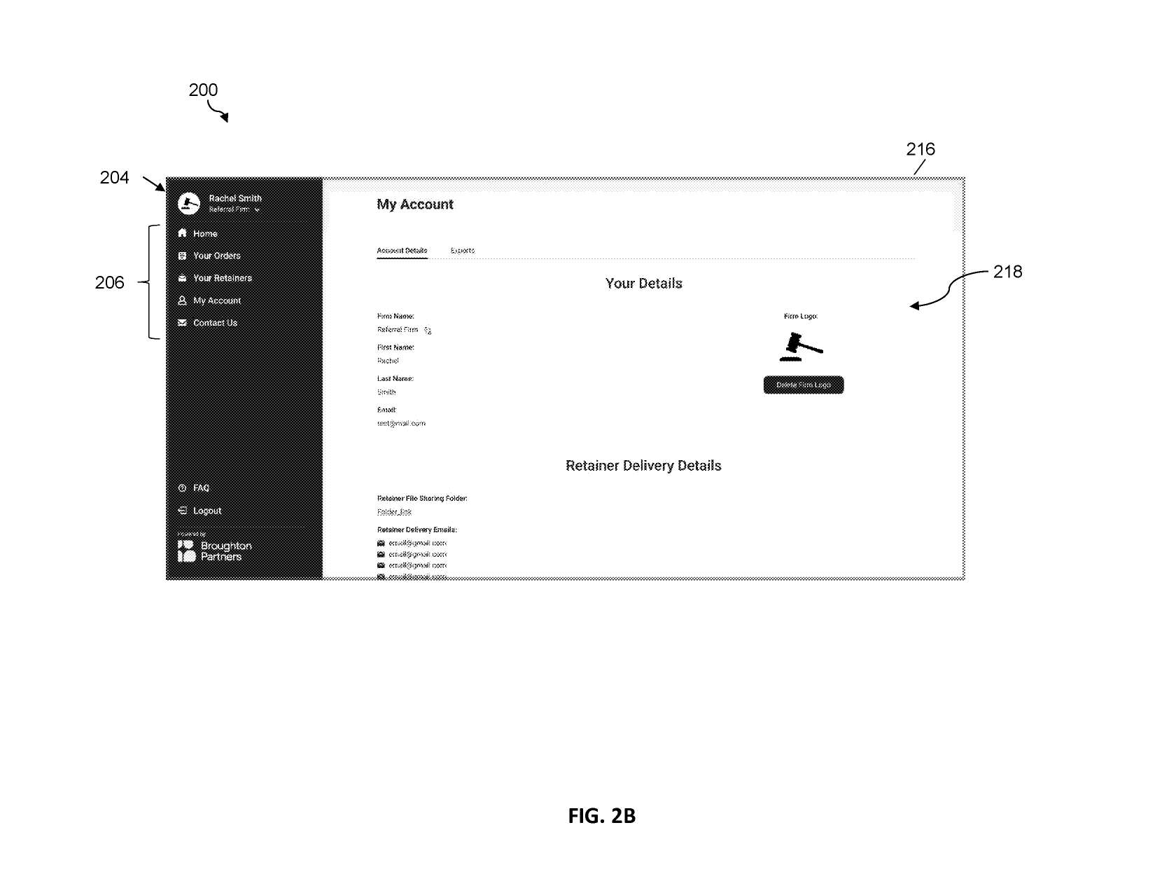

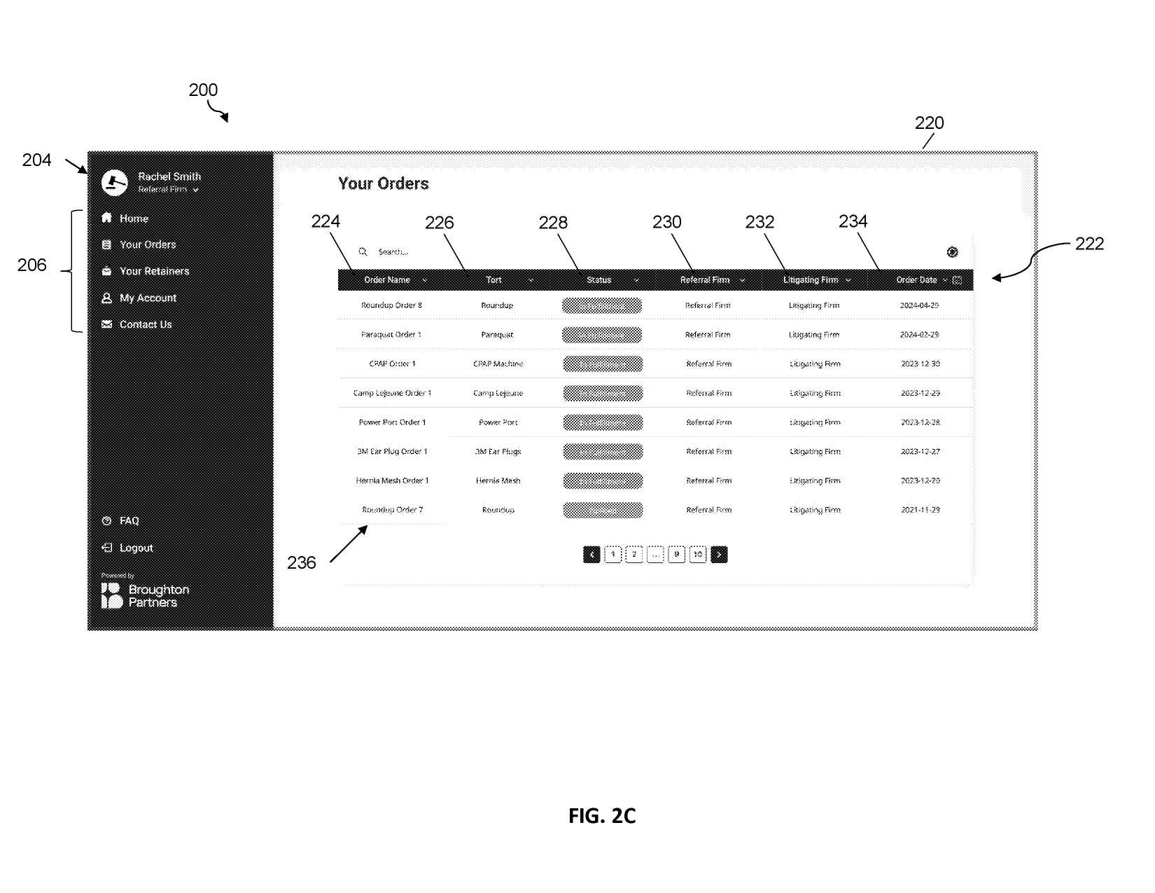

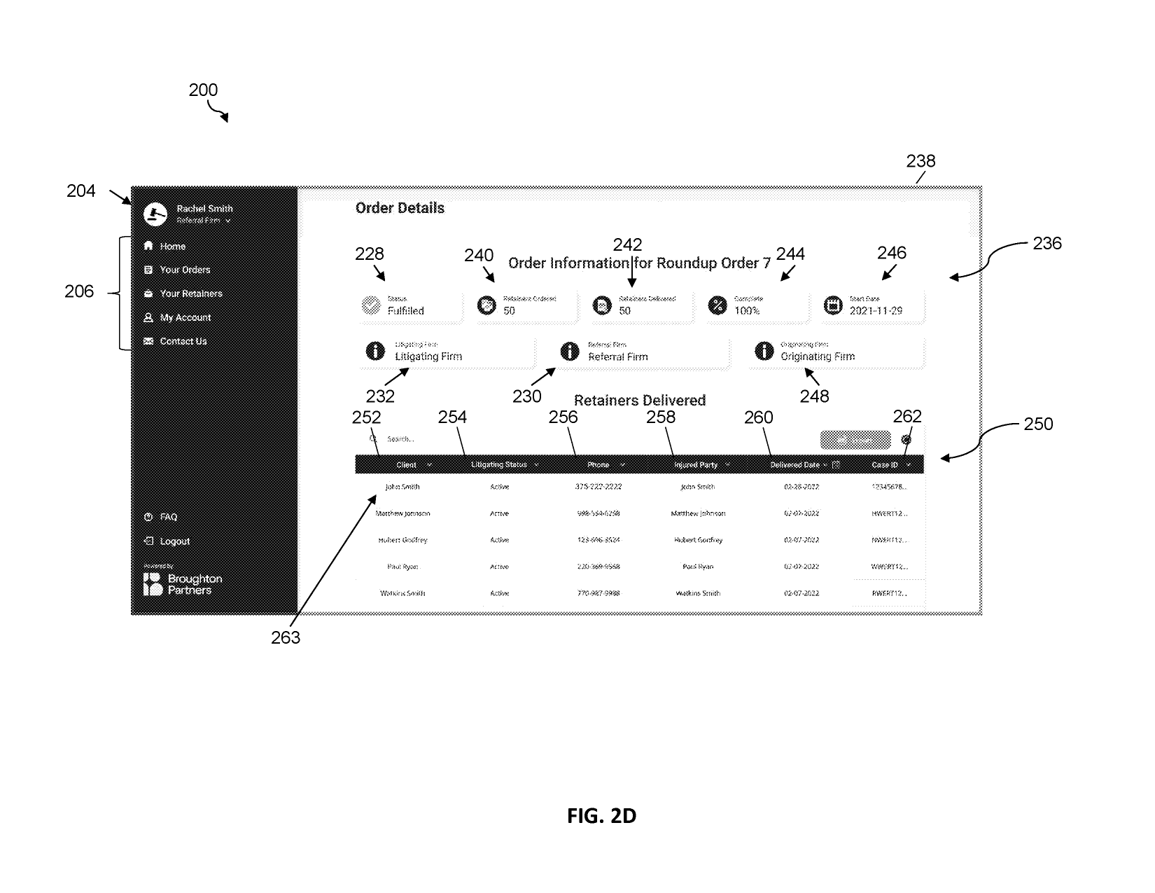

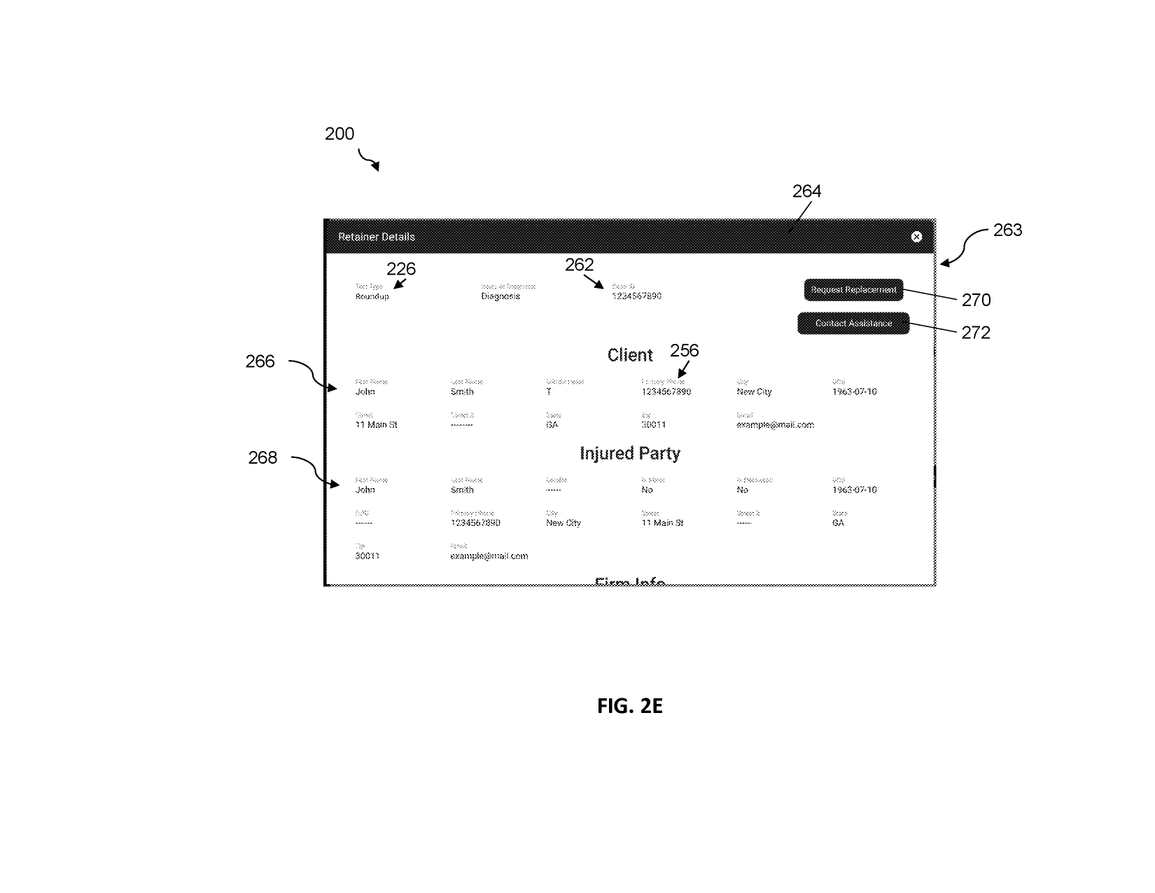

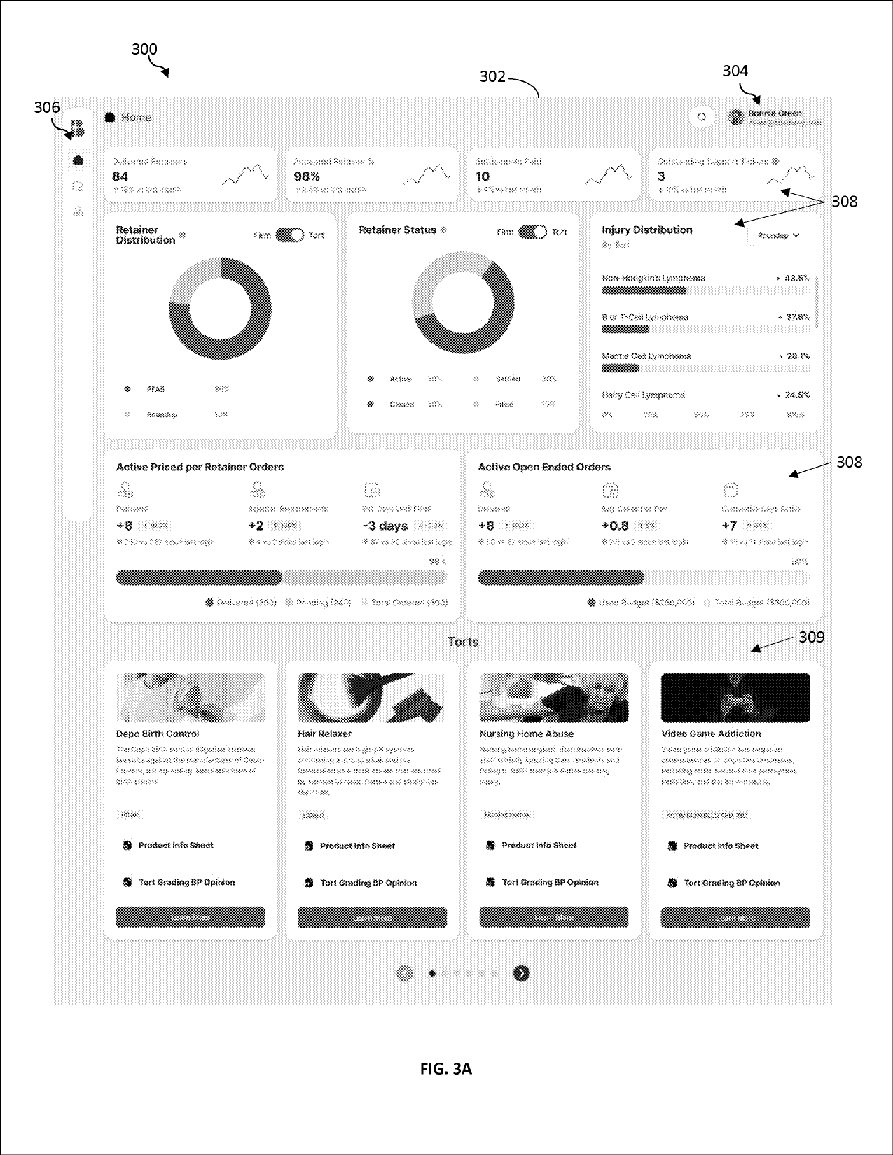

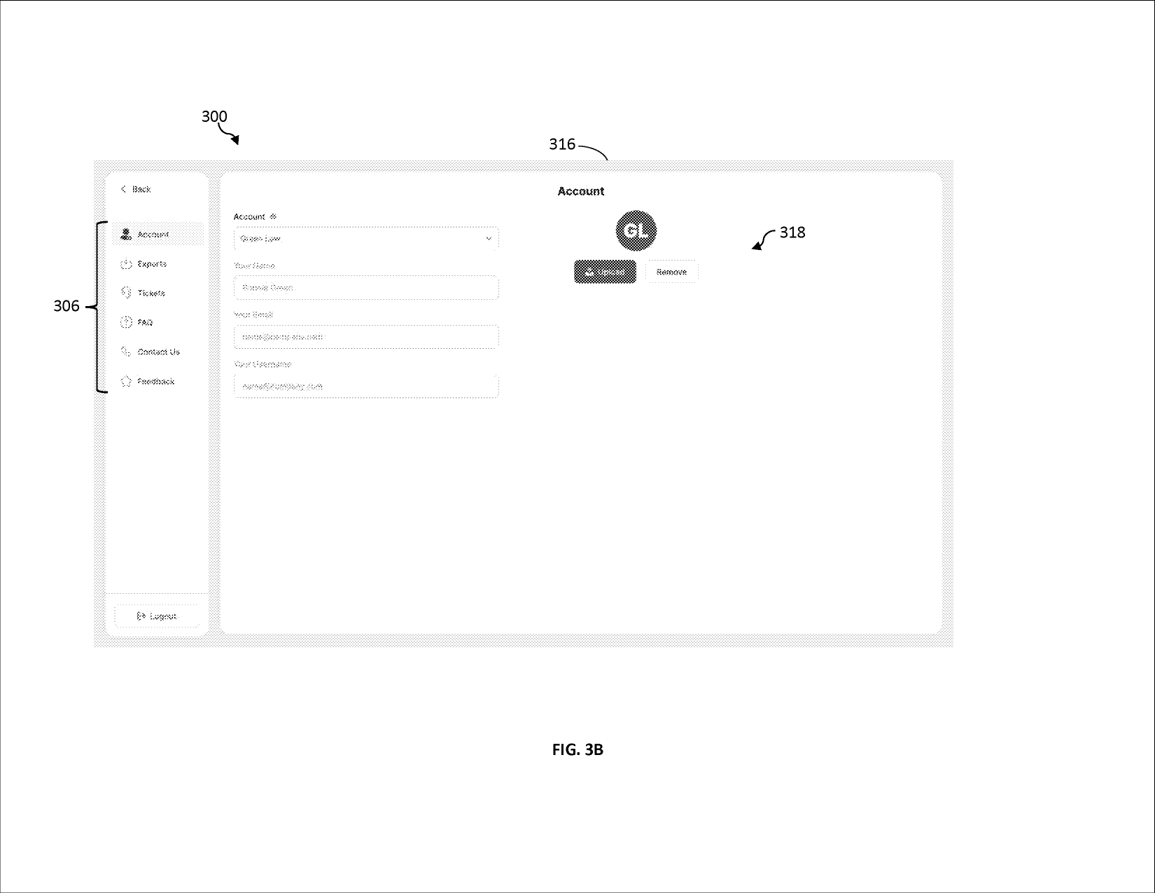

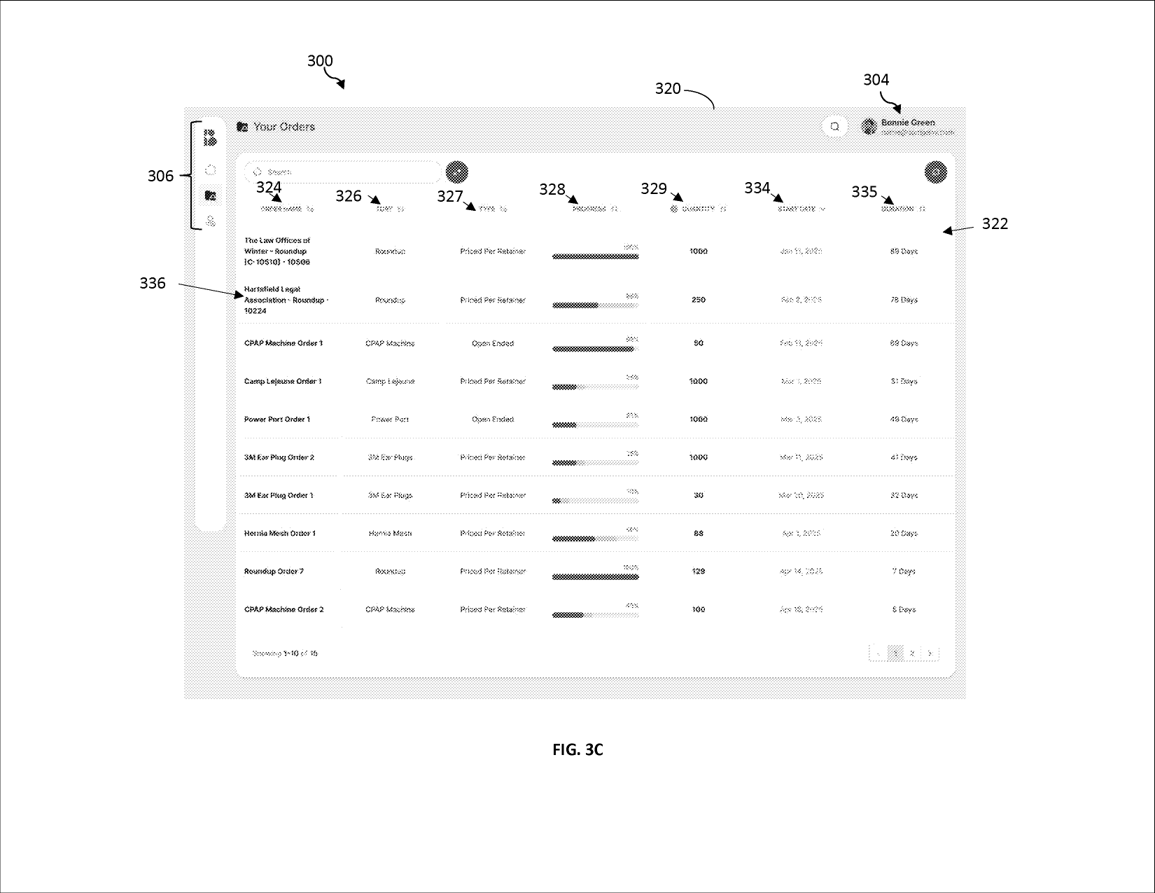

The portal 102 may further send automatic notifications based on actions in the cases management system 104 that trigger status updates and requests in the portal 102, such as retainer request or a request for information. The portal 102 will further be explained in relation to FIGS. 2A-2E and FIGS. 3A-3D.

Describing the permission structure of the portal 102, the portal 102 employs role-based access control (RBAC) integrated with authentication services to manage secure access. Each user account is linked to a specific firm or organizational entity, such as a referral firm, originating firm, litigating firm, or approved third-party partner. Access permissions are determined by the relationship between the firm and the case record’s identifying information including permissive users. When a firm is listed on a case record, its associated users automatically gain visibility into all case data for that case record, while non-associated firms are denied access unless explicitly granted read-only rights by an administrator.

The permission model enforces hierarchical containment, where user accounts inherit permissions from their parent firm account. Cases and documents are mapped to a firm IDs included in the identifying data, and visibility is restricted to records tied to case record linked firm IDs. This structure enables selective data sharing at the account level rather than the document level, ensuring that newly provisioned accounts have access only to cases and files associated with their firm’s case records. A decision-tree process governs data visibility: upon receiving case update information, the portal checks associated case records, determines authorized firm accounts, and either updates and alerts authorized users or hides data from unauthorized firms. This approach ensures confidentiality, compliance, and controlled collaboration across multiple parties.

Describing the internals of the portal 102 further, the portal 102 may include a case file input module 120. The case file input module 120 processes the incoming case files from the connected firms to parse out identifying data and permitted users. Other identify data parsed out may be order data with order data characteristics such as an order number, an order name, a tort type, an order type, or a litigating firm.

The case file input module 120 may parse the data of the case file itself. A case file may include several data points, such as retainer data including a client name, a tort type, a litigating status, client contact data, a case identifier. The case file input module 120 may determine a file format of the case file, e.g., docx, pdf, email, etc., and convert the case file to machine-readable text format to then parse out identifying data, retainer data, etc.

In some examples, the case file input module 120 includes an API connection to the case management systems 104 for receiving case files and sending case files between the firms and portal 102. The API may include identifying data in each communication. Each firm may include a specific workflow to either push update information to the portal 102 or allow the portal 102 to pull data from the case management systems 104. The case file input module 120 may also function to normalize the incoming data form the user’s case management system to machine-readable language that is standard for the portal, such as including one or more identify data in the case file. For example, payloads may be delivered as CSV or JSON format and normalized to the portal’s 102 schema. For example, the portal’s schema may map a firm’s matter ID to a case records existing case ID.

In some examples, the originating firm 112 may manually enter case file into the portal 102 to create a case record pertaining to specific client. In some examples, the originating firm 112 may upload a retainer as a case file which then creates a case record in the portal 102.

The portal may also include a case file identifying module 122. The case file identifying module 122 may operate to match the identifying data, which may include the permitted users, retainer data, and/or order data, to an existing case record in the portal 102. For example, the case file identifying module 122 may match the case ID, the client’s name, the phone number, or more factors to identify an existing case record.

For example, the portal 102 may receive an initial plurality of case files from a client device 106 and/or the case management system 104. The case file identifying module 122 may determine an initial case file does not match an existing case record and create a new case record, including the data of the case file. The new case record may then be stored in the memory 116 and/or the storage 118.

In some examples, the portal 102 may receive case update information containing case files pertaining to existing case records. The case file identifying module 122 may identify the case update information with at least one case record based on a selected certainty of an association of the identifying data included with the case update information. For example, if the identifying data in the case update information matches the identifying data in an existing case record to the selected certainty of, e.g., 60% - 80%, then the case update information should be inserted into the identified case record. In other examples, if at least one value of the identifying data, such as case ID match an existing case record, then the determined certainty is 100%.

The case file identifying module 122 may categorize the received case update information with the identified at least one case record.

The portal 102 may include a case record status module 124 that operates to update the status of a case record upon receiving case update information from the case file identifying module 122. For example, if the case update information is identified as retainer, the case file identifying module 124 may update the corresponding case record as filled.

In some examples, the case record status module 124 may identify gaps in the case record and provide a notification to fill the gap. For example, if the client’s name or contact information is missing from the case record, the case record status module 124 may identify the case record as incomplete and send a notification to the permitted users requesting the missing data. In other examples, the case record status module 124 may use the documents in the case record to fill gaps in the missing data. For example, a last contact data in the case record may be updated based on the date of the latest email to the client.

The portal 102 may also include a case record identifier 126 that operates to query case records according to identifying data or other information included in the case record.

The case record identifier 126 may further categorize the case records into orders with the included order data. Each order may include one or more case records. For example, a referral firm 113 may order a certain number of retainers from an originating firm 112, each retainer being a case file, in this example. The referral firm 113 and the originating firm 112 can both use the portal to see the progress of the order, view the case records, and information in the case records.

The case record identifier 126 may also query special reports just for the firm or specific client device 106 logged into the portal 102. For example, case record identifier 126 may query a retainer status for a logged in user. The retainer status may be active, closed, settled, or filed for each case record. All the case records for the user may be queried to show the status in a graph or other visual to show the retainer status. In another example, the case record identifier 126 may also query the types of torts for each of the case records and query the data for a graph or other visual to show the distribution of the types of torts in the case records. Other queries performed by the case record identifier 126 may include an injury distribution by tort type and/or active open ended orders with further details, as shown in FIG. 3A.

FIGS. 2A – 2E show various screenshots of a user interface (the “UI”) 200 of the portal 102. The portal 102 is not limited to the screenshots shown in FIGS. 2A – 2E but are examples to show the functions of the portal 102 to improve communication between firms. The UI 200 of FIGS. 2A – 2E may be accessed through the client devices 106 by connecting to the portal 102 and logging in. The UI 200 display and data shown will be determined by the client devices’ 106 credentials. For example, the litigating firm 110 will see different data in the portal 102 than the originating firm 112 and vice versa. In the case of FIG. 2A – 2E, the referral firm 113 is logged in.

FIG. 2A shows the UI 200 on a home page 202. The UI 200 may include a user identification 204. The UI 200 may further include a task bar 206 to select the UI’s view page. The home page 202 may include summary statistics 208 include the number of active campaigns, total campaigns, retainers to be delivered, and total retainers delivered. The UI functions to display case records and aggregate case record data. To the extend data is shown on the UI 200, the data is apart of a case record.

The home page 202 may further include a firm history 210 for displaying further statistics. The firm history 210 and summary statistics 208 may be customizable based on the firm that is logged into the portal 102. A statistic displays 212 is shown on the home page 202 as a graph for distinct types of torts 214. The statistic displays 212 shows the count of tort retainers obtained by tort 214.

The summary statistics 208 and the statistic display 212 may update automatically as files are uploaded to the portal 102 by any party, including the litigating firm 110. The summary statistics 208 and the statistic displays 212 may further be updated based on actions in the litigating firm’s case management system 104 when data is shared with the portal 102.

FIG. 2B shows an account page 216 of the UI 200. The account page 216 includes account details 218 for firm that is logged into the portal 102. There may further include a shared folder link for sharing documents between firms and a retainers deliver email list for notifications.

FIG. 2C shows an orders page 220 of the UI 200 which displays the order data. The orders page 220 includes an order status board 222. The order status board 222 shows all the orders assigned to the firm logged into the portal. The orders do not originate from one other firm but are a compilation of any pending order the logged into firm has. For example, multiple litigating firms 110 may have orders for different cases. The orders will be automatically updated based on actions of the logged into firm by fulfilling the order and by the actions of the litigating firm 110 in their case management system 104.

An order on the order status board 222 may include order data such as an order name 224, a tort type 226, a status 228, a referral firm 230 (in this case, the same firm that is logged into the portal 102), an assigned a litigating firm 232 for the order, and an order date 234.

As described above, the status 228 may be updated based on actions of the logged into firm or the litigating firm 110 by acting in its case management system 104 or changing the status 228 on the portal 102. When the logged into firm acts on the order, the status 228 may change to “fulfilled.” In case of the order page 220, the status 228 is an aggregate of the individual case records within each order.

FIG. 2D shows an order details page 238 of the UI 200. In this example, the order details page 238 shows the order details of an example order 236 in FIG. 2C. The order details page 238 shows the status 228, the assigned litigating firm 232, the referral firm 230, and an originating firm 248, which may be the same of the referral firm 230. An order may include multiple tasks to be fulfilled. For example, the example order 236 includes a number of retainers ordered 240 and a number of retainers delivered 242. In this case, the referral firm has received 50 retainers which were ordered from an originating firm. The status board 250 shows a listing of the case records, e.g., retainers, delivered.

The order details page 238 further includes an order completion percentage 244, a start date 246. The status board 250 shows each retainer in the order. The status board 250 shows details of each case record, including a client name 252, the litigating status 254, a phone number 256 of the client, an injured party name 158, a delivered date 260, and a case ID 262. Some or all of this information may be identifying data.

In the case where the originating firm is still fulfilling the order, the status 228 and the number of retainers delivered 242 will be updated on the referral firm’s instance of the portal 102 based on the files uploaded to the litigating firm’s case management system 104. The update will occur through the permission sharing structure. Therefore, the referral firm may view the status 228 without the originating firm having to manually report each retainer.

Through the portal’s 102 connection with the originating firm’s case management system 104, the status 228, the number of retainers delivered 242, and the order completion percentage 244 may be automatically updated. The case ID 262 may be identifying data for the case record to the client’s case, so that it provides a key for data sharing between the portal 102 and a case management system 104.

The litigating status 254 may be automatically updated through a connection to the litigating firm’s case management system 104 by parsing, e.g., court documents or emails. For example, the status may be updated to active, closed, settled, or filed for each case record. In other examples, the litigating firm may login into the portal 102 and update a litigating status 254 of a case file.

The status board 250 and accompanying case record provides real-time visibility into a case events by automatically generating in-portal and email alerts based on system triggers. For example, when a litigating firm files a case and updates its case management system, the portal 102 detects the data sync event and notifies all permitted firms that the case record status has been changed to filed. Additional triggers for emails and status updated in the portal include case filed, e.g., retainer, uploads or signature completion, record requests, document deliveries, and status transitions (e.g., pending, filed, settled). This automated alerting mechanism ensures timely communication, enhances awareness, and supports coordinated action across all participating firms.

FIG. 2E shows a retainer details page 264 of the UI 200. The retainer details page 264 is an example of the data in a case file. In the example, the retainer details page 264 shows the retainer details of an example retainer 263 in FIG. 2D. The retainer details page 264 shows such details such as the tort type 226, the case ID 262, client details 266, and injured party details 168. The client details 266 include the client’s name 252, phone number 256, and other details such as contact information and date of birth. The injured party details 268 may be the same as the client details 266 and may be the same person. The retainer details page 264 may also include the responsible litigating firm(s), originating firm, and referral firm as one or more permissive parties to the case record.

The retainer details page 264 may further include the option to request a replacement retainer 270 from the originating firm 112. The originating firm 112 will then be notified on their portal to replace the retainer. There is also a contact assistance 272 button for technical support and further corrections.

FIGS. 3A – 3D show various screenshots of a user interface (the “UI”) 300 of the portal 102. The UI 200 and the UI 300 may be interchangeable and represent different displays of the portal 102. The UI 200 and the UI 300 may display the same information. The portal 102 functionality in the UI 200 may also be included in the UI 300.

The UI 300 specific display and data shown will be determined by the client devices 106 credentials. For example, the litigating firm 110 will see different data in the portal 102 than the originating firm 112 and vice versa. In the case of FIG. 3A – 3D, the referral firm 113 is logged in.

FIG. 3A shows the UI 300 on a home page 302. The UI 300 may include a user identification 304. The UI 300 may further include a task bar 306 to select the UI’s view page. The home page 302 may include summary statistics 308 include the number of active campaigns, total campaigns, retainers to be delivered, and total retainers delivered.

The home page 302 may further include a firm history 310 for displaying further statistics. The summary statistics 308 may be customizable based on the firm that is logged into the portal 102. The summary statistics may include a statistic displays as a graph for different types of torts, the retainer distribution, the retainer status, the injury distribution by tort, active priced per retainer orders, and/or active open ended orders. The summary statistics 308 and corresponding graphic may be aggregate of different queries of the case records and/or active orders.

The summary statistics 308 may update automatically as case files are uploaded to the portal 102 by any party, including the litigating firm 110 and originating firm 112. For example, the summary statistics 308 may be updated as retainers are uploaded or added by the originating firm 112.

FIG. 3A also shows a tort hub 309. The tort hub 309 provides for aggregated news, legal analyses, and research insights, ensuring that all content is curated for accuracy, relevance, and value to the user community. This structure enables efficient access to comprehensive, high-quality tort information within a single interface on the home page 302.

FIG. 3B shows an account page 316 of the UI 300. The account page 316 includes account details 318 for firm that is logged into the portal 102. In the case of FIG. 3A – 3D, the referral firm is logged in.

FIG. 3C shows an orders page 320 of the UI 300 which displays the order data. The orders page 320 includes an order status board 322. The order status board 322 shows all the orders assigned to the firm logged into the portal. The orders do not originate from one other firm but are a compilation of any pending order the logged into firm has. The orders may be automatically updated based on actions of the logged into firm by fulfilling the order and by the actions of the litigating firm 110 in their case management system 104.

An order on the order status board 322 may include an order name 324, a tort type 326, an order type 327 (e.g., price per retainer or open ended), a progress bar 328, a quantity 329 (e.g., the quantity of retainers requested), an order date 334, and a duration 335 of the order. The duration 335 may be the number of days left to fulfill the order from the current date or the be the number of days the order is active from the order date 334. In another embodiment, the duration 335 is the end date for the order.

The progress bar 328 may be updated based on actions of the referral firm 113, the litigating firm 110, or the originating firm 112 by acting in its respective case management system 104, uploading case files, or changing the progress bar 328 on the portal 102. When as a firm acts on the order, the progress bar 328 percentage may change. In case of the order page 320, the progress bar 328 is an aggregate of the individual case records within each order. For example, as the originating firm uploads retainers, e.g., case files, to the portal, the order is being fulfilled and the progress 328 bar may increase. An example order 336 is further described in FIG. 3D.

FIG. 3D shows an order details page 338 of the UI 300 for one specific order. In this example, the order details page 338 shows the order details of an example order 336 in FIG. 3C.

The order details page 338 may show the order name 324, the tort type 326, an order type 327, an order number 337, and/or the assigned litigating firm 332. The order details page 338 may also show the progress bar 328 with further details on the retainers that are delivered to the referring firm, pending, and a total ordered.

The status board 350 shows each retainer in the order. The status board 350 shows details of each case record, including a client name 352, the litigating status 354, a phone number 356 of the client, an email 357 of the client, a delivered date 360, and a case ID 362. Some or all of this information may be identifying data of the case record.

Where the originating firm is still actively fulfilling the order, the progress bar 328, will be updated on the referral firm’s instance of the portal 102 as the originating firm uploads case files, e.g., retainers. The update may occur through the permission sharing structure with the originating firm’s case management system. Therefore, the referral firm may view the progress bar 328 without the originating firm having to manually report each retainer.

The litigating status 354 may be automatically updated through a connection to the litigating firm’s case management system 104. In other examples, the litigating firm may login into the portal 102 and update a litigating status 354 of a case file.

As the retainers are delivered by the originating firm, the status board 350 will automatically populate with case records representing each client’s case in the order.

The portal 102, including the UI 200 and/or the UI 300 may provide for creating a ticket pertaining to one or more case records. A ticket facilitates collaborative issue resolution between the different firms by providing shared access to ticket threads within the portal 102. When a request is raised against a case record, all firms listed on that case record are automatically notified. Permitted users can view the ticket, post comments, and attach supporting documents directly within the portal 102. This centralized approach improves transparency, streamlines communication, and eliminates fragmented email-based tracking, ensuring efficient and auditable collaboration across multiple parties.

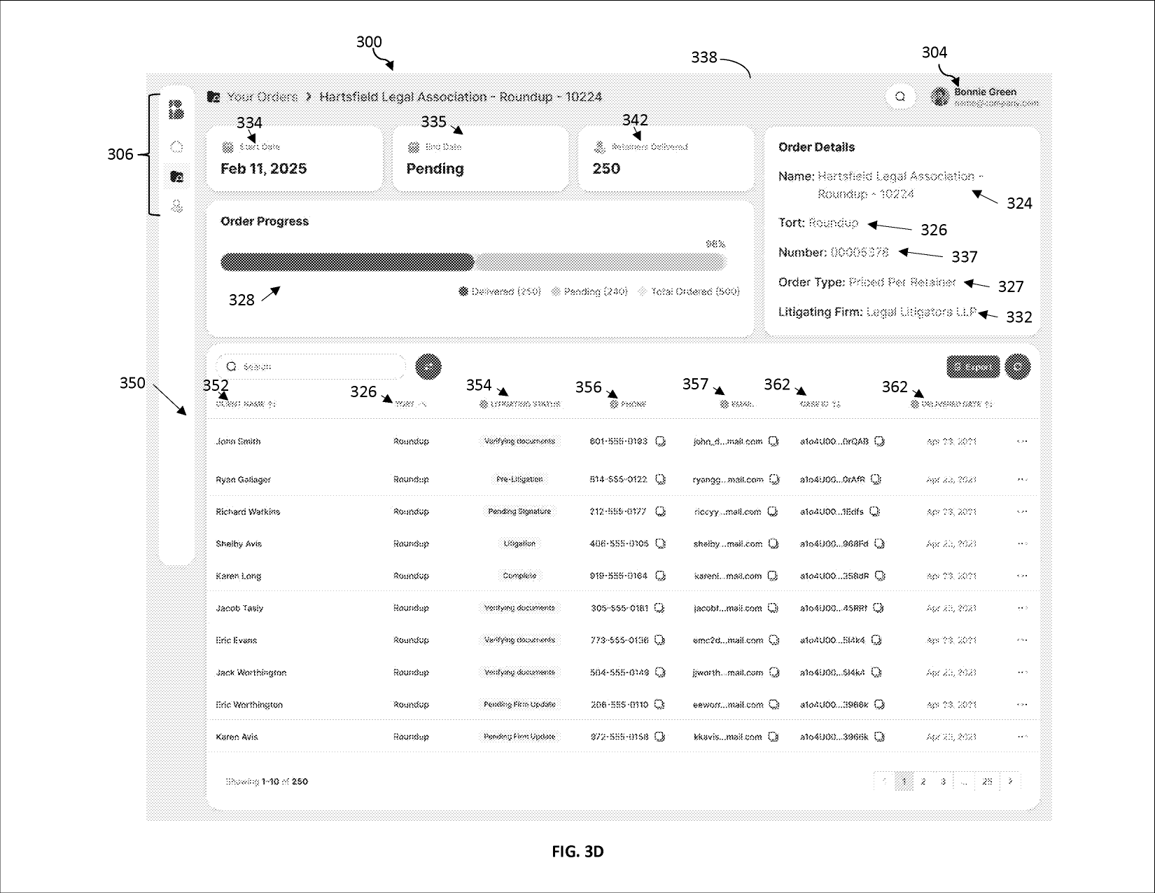

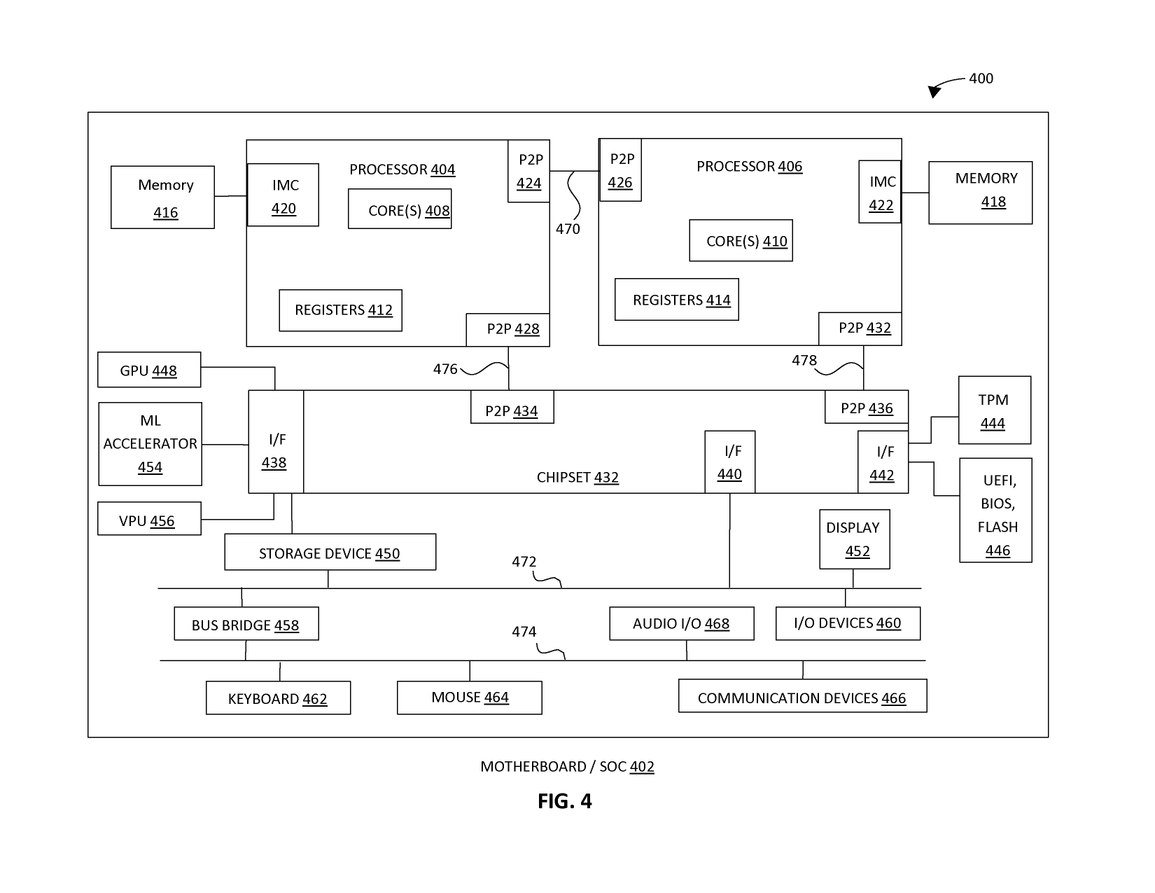

FIG. 4 illustrates an embodiment of a system 400 that may be suitable for implementing various embodiments described hereby. System 400 is a computing system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, and the like. Further embodiments implement larger scale server configurations. In other embodiments, the system 400 may have a single processor with one core or more than one processor. Note that the term “processor” refers to a processor with a single core or a processor package with multiple processor cores.

In at least one embodiment, the computing system 400, or one or more components thereof, is representative of one or more components described hereby, such as the partner portal system 100, the client devices 106, the case management system 104, and the portal 102. More generally, the computing system 400 may be configured to implement embodiments including logic, systems, logic flows, methods, apparatuses, and functionality described hereby. The embodiments, however, are not limited to implementation by the system 400.

As used in this application, the terms “system” and “component” and “module” are generally intended to refer to a computer-related entity, either hardware, a combination of hardware and software, software, or software in execution, examples of which are provided by the exemplary system 400. For example, a component can be, but is not limited to being, a process running on a processor, a processor, a hard disk drive, multiple storage drives (of optical, solid-state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Although not necessarily illustrated, the computing system 400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. Further, the computing system 400 may include or implement various articles of manufacture. An article of manufacture may include a non-transitory computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, encrypted code, and the like, implemented using any suitable high-level, low-level, object-oriented, visual, compiled, and/or interpreted programming language. Embodiments may also be at least partly implemented as instructions contained in or on a non-transitory computer-readable medium, which may be read and executed by one or more processors to enable performance of the operations described herein.

As illustrated in FIG. 4, the system 400 comprises a motherboard or system-on-chip (SoC) 402 for mounting platform components. Motherboard or system-on-chip (SoC) 402 is a point-to-point (P2P) interconnect platform that includes a first processor 404 and a second processor 406 coupled via a point-to-point interconnect 470 such as an Ultra Path Interconnect (UPI). In other embodiments, the system 400 may be of another bus architecture, such as a multi-drop bus. Furthermore, each of processor 404 and processor 406 may be processor packages with multiple processor cores including core(s) 408 and core(s) 410, respectively. While the system 400 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 404 and chipset 432. Some platforms may include additional components, and some platforms may only include sockets to mount the processors and/or the chipset. Furthermore, some platforms may not have sockets (e.g., SoC, or the like).

The processor 404 and processor 406 can be any of various commercially available processors. Dual microprocessors, multi-core processors, and other multi-processor architectures may also be employed as the processor 404 and/or processor 406. Additionally, the processor 404 need not be identical to processor 406.

Processor 404 includes an integrated memory controller (IMC) 420 and point-to-point (P2P) interface 424 and P2P interface 428. Similarly, the processor 406 includes an IMC 422 as well as P2P interface 426 and P2P interface 430. IMC 420 and IMC 422 couple the processors processor 404 and processor 406, respectively, to respective memories (e.g., memory 416 and memory 418). Memories 416, 418 can store instructions executable by circuitry of system 400 (e.g., processor 404, processor 406, graphics processing unit (GPU) 448, ML accelerator 454, vision processing unit (VPU) 456, or the like). For example, memories 416, 418 can store instructions for one or more of the client devices 106, the case management system 104, the portal 102, and the like. Memory 416 and memory 418 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 416 and memory 418 locally attach to the respective processors (i.e., processor 404 and processor 406). In other embodiments, the main memory may couple with the processors via a bus and/or shared memory hub.

System 400 includes chipset 432 coupled to processor 404 and processor 406. Furthermore, chipset 432 can be coupled to storage device 450, for example, via an interface (I/F) 438. The I/F 438 may be, for example, a Peripheral Component Interconnect-enhanced (PCI-e). In many embodiments, storage device 450 comprises a non-transitory computer-readable medium. Storage device 450 can store instructions executable by circuitry of system 400 (e.g., processor 404, processor 406, GPU 448, ML accelerator 454, vision processing unit 456, or the like). For example, storage device 450 can store instructions for one or more of the portal 102, the case management system 104, and the like. In another example, storage device 450 can store data, such as retainer details 164, client details 266, injured party details 268, case information, and the like. In some embodiments, instructions may be copied or moved from storage device 450 to memory 416 and/or memory 418 for execution, such as by processor 404 and/or processor 406.

Processor 404 couples to a chipset 432 via P2P interface 428 and P2P interface 434 while processor 406 couples to a chipset 432 via P2P interface 430 and P2P interface 436. Direct media interface (DMI) 476 and DMI 478 may couple the P2P interface 428 and the P2P interface 434 and the P2P interface 430 and P2P interface 436, respectively. DMI 476 and DMI 478 may be a high-speed interconnect that facilitates, e.g., eight Giga Transfers per second (GT/s) such as DMI 3.0. In other embodiments, the components may interconnect via a bus.

The chipset 432 may comprise a controller hub such as a platform controller hub (PCH). The chipset 432 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 432 may comprise more than one controller hub such as a chipset with a memory controller hub, a graphics controller hub, and an input/output (I/O) controller hub.

In the depicted example, chipset 432 couples with a trusted platform module (TPM) 444 and UEFI, BIOS, FLASH circuitry 446 via I/F 442. The TPM 444 is a dedicated microcontroller designed to secure hardware by integrating cryptographic keys into devices. The UEFI, BIOS, FLASH circuitry 446 may provide pre-boot code.

Furthermore, chipset 432 includes the I/F 438 to couple chipset 432 with a high-performance graphics engine, such as, graphics processing circuitry or a graphics processing unit (GPU) 448. In other embodiments, the system 400 may include a flexible display interface (FDI) (not shown) between the processor 404 and/or the processor 406 and the chipset 432. The FDI interconnects a graphics processor core in one or more of processor 404 and/or processor 406 with the chipset 432.

Additionally, ML accelerator 454 and/or vision processing unit 456 can be coupled to chipset 432 via I/F 438. ML accelerator 454 can be circuitry arranged to execute ML related operations (e.g., training, inference, etc.) for ML models. Likewise, vision processing unit 456 can be circuitry arranged to execute vision processing specific or related operations. In particular, ML accelerator 454 and/or vision processing unit 456 can be arranged to execute mathematical operations and/or operands useful for machine learning, neural network processing, artificial intelligence, vision processing, etc.

Various I/O devices 460 and display 452 couple to the bus 472, along with a bus bridge 458 which couples the bus 472 to a second bus 474 and an I/F 440 that connects the bus 472 with the chipset 432. In one embodiment, the second bus 474 may be a low pin count (LPC) bus. Various I/O devices may couple to the second bus 474 including, for example, a keyboard 462, a mouse 464, and communication devices 466.

Furthermore, an audio I/O 468 may couple to second bus 474. Many of the I/O devices 460 and communication devices 466 may reside on the motherboard or system-on-chip(SoC) 402 while the keyboard 462 and the mouse 464 may be add-on peripherals. In other embodiments, some or all the I/O devices 460 and communication devices 466 are add-on peripherals and do not reside on the motherboard or system-on-chip(SoC) 402. More generally, the I/O devices of system 400 may include one or more of microphones, speakers, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, displays, augmented/virtual reality devices, printers, actuators, motors, transducers, and the like.

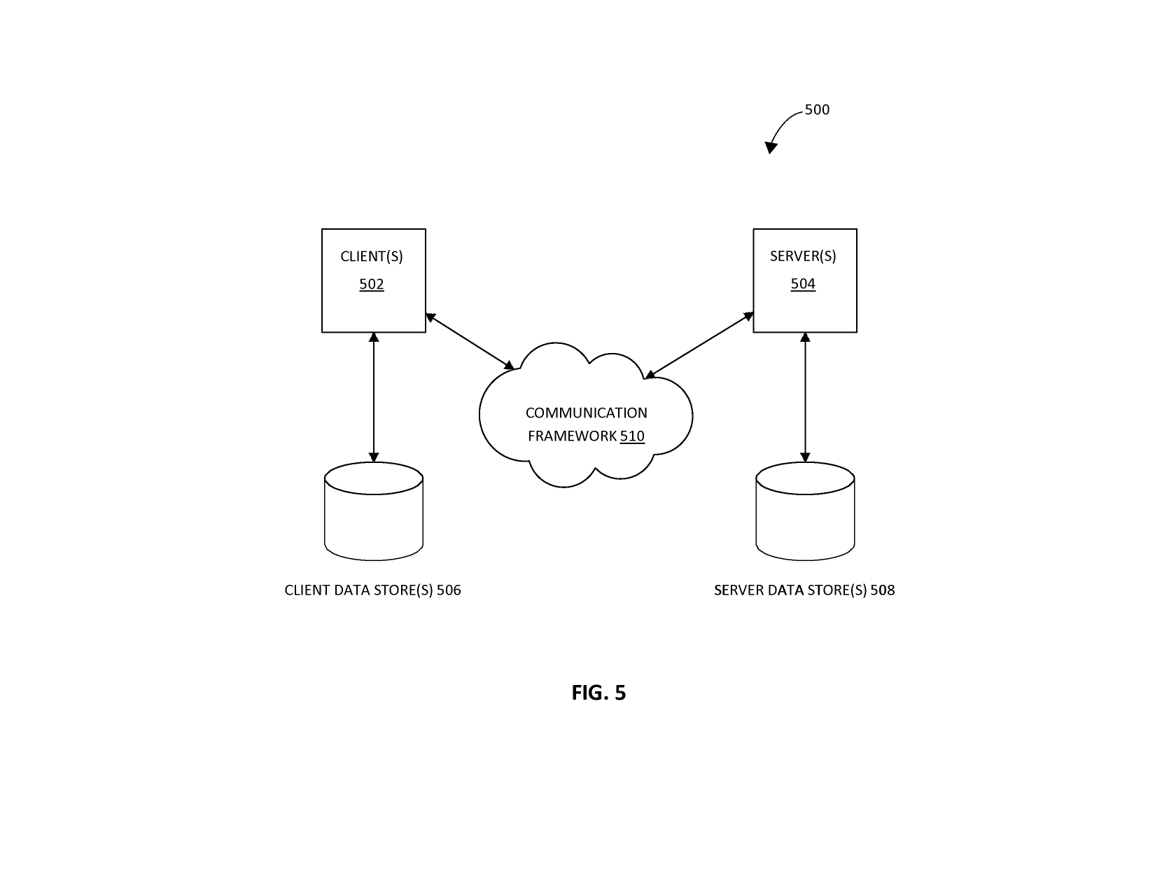

FIG. 5 is a block diagram depicting an exemplary communications architecture 500 suitable for implementing various embodiments as previously described, such as communications between the case management system 104 and the client device 106, between the case management system 104 and the portal 102, and between the portal 102 and client devices 106. The communications architecture 500 includes various common communications elements, such as a transmitter, receiver, transceiver, radio, network interface, baseband processor, antenna, amplifiers, filters, power supplies, and so forth. The embodiments, however, are not limited to implementation by the communications architecture 500.

As shown in FIG. 5, the communications architecture 500 includes one or more client(s) 502 and server(s) 504. In some embodiments, each client 502 and/or server 504 may include a computing system (e.g., system 400) The server(s) 504 may implement one or more devices of the partner portal system 100. The partner portal system 100 may use the communication architecture 500 to communicate between the different firms, e.g., the litigating firm 110, the originating firm 112, and the referral firm 113 and their respective client devices 106 and case management system 104.

The client(s) 502 and the server(s) 504 are operatively connected to one or more respective client data store(s) 506 and server data store(s) 508 that can be employed to store information local to the respective client(s) 502 and server(s) 504, such as cookies and/or associated contextual information. In various embodiments, any one of server(s) 504 may implement one or more logic flows or operations described hereby, such as in conjunction with storage of data received from any one of client(s) 502 on any of server data store(s) 508. In one or more embodiments, one or more of client data store(s) 506 or server data store(s) 508 may include memory accessible to one or more portions of components, applications, and/or techniques described hereby.

The client(s) 502 and the server(s) 504 may communicate information between each other using a communication framework 510. The communication framework 510 may implement any well-known communications techniques and protocols. The communication framework 510 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators). In some embodiments, the communication framework 510 can be at least partially implemented on a cloud-computing network.

The communication framework 510 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 502 and the server(s) 504. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

FIG. 6 illustrates an example workflow for a partner portal system, according to exemplary embodiments. The workflow 600 may be performed by the partner portal system 100 described above and included within the UIs 200 and 300.

FIG. 6 provides an example of off-portal activities done by a firm and an example of on-portal data processing. As used in FIG. 6, the non-litigating firm may be any of the entities described in the description, such as the litigating firm 110, the originating firm 112, and the referral firm 113, depending on their actions in the portal.

For example, the workflow 600, at step 602 may include the non-litigating firm(s) sourcing possible claim(s). In this example, the non-litigating firm, e.g., the originating firm 112 and/or the referral firm 113 is advertising for claimants.

Next, the workflow 600, at step 604, may include performing additional claim vetting. Here the non-litigating firm vets the potential plaintiffs/clients to see if they have a valid tort claim.

Next, the workflow 600, at step 606, the non-litigating firm(s) may set terms with a litigating firm. For example, the originating firm 112 and/or the referral firm 113 may enter into a contract with a litigating firm 110 to litigate the vetted claim. In other examples, the terms being set are for future vetted claims at a set price, e.g., described above in relation to order data on the portal. At step 608, the contract terms are disseminated to firms and claimant(s).

Now on the portal, e.g., the portal 102 and shown with the UIs 200 and 300, the workflow 600 includes, at step 610, the non-litigating firm(s) publishing case files. This creates the case record on the portal for the claimant and associated firms to view, update, track, and modify.

The workflow 600 may then include step 612, the non-litigating firm(s) configuring access for litigating firm. For example, the non-litigating firm may authorize the litigating firm to access a case record. Then, at step 614, the litigating firm may publish litigation updates to the case record. At step 616, the portal may notify the non-litigating firm(s) of case record updates made by the litigating firm at step 614. Furthermore, the non-litigating firm(s) may monitor the progress of the case record and claim progress at step 618.

The workflow 600 may then include step 620. Step 620 includes the litigating firm closing the case record. Optionally, at step 622 a notice of settlement distribution is published to the portal.

FIG. 6 is illustrated as a flowchart illustrating off-portal and portal steps, however any steps may not necessary be performed in order as indicated by the arrows. Furthermore, each step may take place in a cloud environment such as client-server design.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. For example, the client devices 106, the case management systems 104, and the portal 102 may utilize at least one microprocessor.

The various devices, components, modules, features, and functionalities described hereby may include, or be implemented via, various hardware elements, software elements, or a combination of both. Examples of hardware elements may include devices, logic devices, hardware components, processors, microprocessors, circuits, circuitry, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, algorithms, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation. It is noted that hardware, firmware, and/or software elements may be collectively or individually referred to herein as “logic,” “circuit,” or “circuitry.”

One or more aspects of at least one embodiment may be implemented by representative instructions stored on a machine-readable medium which represents various logic within the processor, which when read by a machine causes the machine to fabricate logic to perform the techniques described hereby. Such representations, known as “IP cores,” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, and the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, and the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software, and/or elements for implementing these functions would necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referral to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, and the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include digital computers or similar devices.

Some embodiments may be described using the expression "coupled" and "connected" along with their derivatives. These terms are not necessarily intended as synonyms for each other. For example, some embodiments may be described using the terms “connected” and/or “coupled” to indicate that two or more elements are in direct physical or electrical contact with each other. The term "coupled,” however, may also mean that two or more elements are not in direct contact with each other, but yet still co-operate or interact with each other.

Various embodiments also relate to apparatus or systems for performing these operations. This apparatus may be specially constructed for the required purpose, or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein.

While the apparatus and method have been described with reference to specific embodiments, it will be understood by those skilled in the art that various changes may be made, and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment,” “some embodiments,” “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur - this distinction is captured by the terms “may” and “may be.”

As used herein, the terms “comprises,” “comprising,” “includes,” “including,” “has,” “having,” or any other variation thereof, are intended to cover assembly in a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. Furthermore, the word “comprises,” and its grammatical variants will be understood to logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the method, machine, and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

As explained above and reiterated below, the present disclosure includes, without limitation, the following example implementations:

Clause 1. A case management system, comprising: a portal comprising a processor and a memory operably coupled to the processor and having computer-readable instructions stored thereon that, when executed by the processor, cause portal to: receive an initial plurality of case files, each of the case files including identifying data and one or more permitted users associated with one or more of the case files; create and store a case record for each case file, including the identifying data and permitted users; receive a case update information related to the case file from one or more of the permitted users; identifying the case update information with at least one case record based on a selected certainty of an association of the identifying data included with the case update information; and categorizing the received case update information with the identified at least one case record, including determining a status of the case record; and a user interface configured to enable a user to select one or more parameters relating one or more case records for compiling a customized case analysis.

Clause 2. The case management system of any of the clauses, wherein the user interface comprises a graphical or web-based interface configured to enable visual navigation and display of the one or more selected case records of the customized case analysis.

Clause 3. The case management system of any of the clauses, wherein the computer-readable instructions comprise, when executed by the processor, further cause the portal to: determine a file format of the case update information; and convert the case update information into a machine-readable text format.

Clause 4. The case management system of any of the clauses, wherein the computer-readable instructions comprise when executed by the processor, further cause the portal to: determine the identifying data of the case update information based on the machine-readable text format.

Clause 5. The case management system of any of the clauses, wherein the computer-readable instructions comprise when executed by the processor, further cause the portal to: generate a notification to one or more of the permitted users of the case record of a new case file update based on identified case update information with the at least one case record.

Clause 6. The case management system of any of the clauses, wherein: each of the case files further includes retainer data, wherein the retainer data comprises one or more of: a client name, a tort type, a litigating status, client contact data, or a case identifier; and the creating and storing the case record for each case file, includes storing the retainer data in the case record.

Clause 7. The case management system of any of the clauses, wherein the categorizing the received case update information with the identified at least one case record, including determining the status of the case record further comprises: updating one or more of the client name, the tort type, the litigating status, the client contact data, or the case identifier in the case file.

Clause 8. The case management system of any of the clauses, wherein the identifying data includes order data identifying the case file.

Clause 9. The case management system of any of the clauses, wherein the user interface is configured to display case files with a same characteristic of the order data.

Clause 10. The case management system of any of the clauses, wherein the characteristic of the order data comprises one or more of: an order number, an order name, a tort type, an order type, or a litigating firm.

Clause 11. The case management system of any of the clauses, wherein the permitted users associated with at least one case file comprise a first firm and a second firm.

Clause 12. A method for operating a case management system, the case management system comprising a portal and a user interface, and the method comprising: receiving an initial plurality of case files, each of the case files including identifying data and one or more permitted users associated with one or more of the case files; creating and storing a case record for each case file, including the identifying data and permitted users; receiving a case update information related to the case file from one or more of the permitted users; identifying the case update information with at least one case record based on a selected certainty of an association of the identifying data included with the case update information; categorizing the received case update information with the identified at least one case record, including determining a status of the case record; and receiving a user input of a selection one or more parameters relating to one or more case records for compiling a customized case analysis.

Clause 13. The method of any of the clauses, wherein the case management system further comprises a user interface, the user interface comprises a graphical or web-based interface, and the method further comprises: enable visual navigation of the one or more case records on the user interface; and display of the one or more selected case records of the customized case analysis.

Clause 14. The method of any of the clauses, further comprising: determining a file format of the case update information; converting the case update information into a machine-readable text format; and determining the identifying data of the case update information based on the machine-readable text format.

Clause 15. The method of any of the clauses, wherein: the case file further includes retainer data, wherein the retainer data comprises one or more of: a client name, a tort type, a litigating status, client contact data, or a case identifier; and the creating and storing the case record for each case file further includes storing the retainer data in the case record.

Clause 16. The method of any of the clauses, wherein the categorizing the received case update information with the identified at least one case record, including determining the status of the case record further comprises: updating one or more of the client name, the tort type, the litigating status, the client contact data, or the case identifier in the case file.

Clause 17. A non-transitory machine-readable medium having executable instructions to cause one or more processing units to perform a method for operating a case management system, the case management system comprising a portal and a user interface, and the method comprising: receiving an initial plurality of case files, each of the case files including identifying data and one or more permitted users associated with one or more of the case files; creating and storing a case record for each case file, including the identifying data and permitted users; receiving a case update information related to the case file from one or more of the permitted users; identifying the case update information with at least one case record based on a selected certainty of an association of the identifying data included with the case update information; categorizing the received case update information with the identified at least one case record, including determining a status of the case record; and receiving a user input of a selection one or more parameters relating to one or more case records for compiling a customized case analysis.

Clause 18. The non-transitory machine-readable medium of any of the clauses, wherein the case management system further comprises a user interface, the user interface comprises a graphical or web-based interface, and the method further comprises: enable visual navigation of the one or more case records on the user interface; and display of the one or more selected case records of the customized case analysis.

Clause 19. The non-transitory machine-readable medium of any of the clauses, wherein: the case file further includes retainer data, wherein the retainer data comprises one or more of: a client name, a tort type, a litigating status, client contact data, or a case identifier; and the creating and storing the case record for each case file further includes storing the retainer data in the case record.

Clause 20. The non-transitory machine-readable medium of any of the clauses, wherein the categorizing the received case update information with the identified at least one case record, including determining the status of the case record further comprises: updating one or more of the client name, the tort type, the litigating status, the client contact data, or the case identifier in the case file.

What is claimed is:

1. A case management system, comprising:
a portal comprising a processor and a memory operably coupled to the processor and having computer-readable instructions stored thereon that, when executed by the processor, cause portal to:
receive an initial plurality of case files, each of the case files including identifying data and one or more permitted users associated with one or more of the case files;
create and store a case record for each case file, including the identifying data and permitted users;
receive a case update information related to the case file from one or more of the permitted users;
identifying the case update information with at least one case record based on a selected certainty of an association of the identifying data included with the case update information; and
categorizing the received case update information with the identified at least one case record, including determining a status of the case record; and
a user interface configured to enable a user to select one or more parameters relating one or more case records for compiling a customized case analysis.

2. The case management system of claim 1, wherein the user interface comprises a graphical or web-based interface configured to enable visual navigation and display of the one or more selected case records of the customized case analysis.

3. The case management system of claim 1, wherein the computer-readable instructions comprise, when executed by the processor, further cause the portal to:
determine a file format of the case update information; and
convert the case update information into a machine-readable text format.

4. The case management system of claim 3, wherein the computer-readable instructions comprise when executed by the processor, further cause the portal to:
determine the identifying data of the case update information based on the machine-readable text format.

5. The case management system of claim 1, wherein the computer-readable instructions comprise when executed by the processor, further cause the portal to:
generate a notification to one or more of the permitted users of the case record of a new case file update based on identified case update information with the at least one case record.

6. The case management system claim 1, wherein:
each of the case files further includes retainer data, wherein the retainer data comprises one or more of: a client name, a tort type, a litigating status, client contact data, or a case identifier; and
the creating and storing the case record for each case file, includes storing the retainer data in the case record.

7. The case management system of claim 6, wherein the categorizing the received case update information with the identified at least one case record, including determining the status of the case record further comprises:
updating one or more of the client name, the tort type, the litigating status, the client contact data, or the case identifier in the case file.

8. The case management system claim 1, wherein the identifying data includes order data identifying the case file.

9. The case management system claim 8, wherein the user interface is configured to display case files with a same characteristic of the order data.

10. The case management system claim 9, wherein the characteristic of the order data comprises one or more of: an order number, an order name, a tort type, an order type, or a litigating firm.

11. The case management system of claim 1, wherein the permitted users associated with at least one case file comprise a first firm and a second firm.

12. A method for operating a case management system, the case management system comprising a portal and a user interface, and the method comprising:
receiving an initial plurality of case files, each of the case files including identifying data and one or more permitted users associated with one or more of the case files;
creating and storing a case record for each case file, including the identifying data and permitted users;
receiving a case update information related to the case file from one or more of the permitted users;
identifying the case update information with at least one case record based on a selected certainty of an association of the identifying data included with the case update information;
categorizing the received case update information with the identified at least one case record, including determining a status of the case record; and
receiving a user input of a selection one or more parameters relating to one or more case records for compiling a customized case analysis.

13. The method of claim 12, wherein the case management system further comprises a user interface, the user interface comprises a graphical or web-based interface, and the method further comprises:
enable visual navigation of the one or more case records on the user interface; and
display of the one or more selected case records of the customized case analysis.

14. The method of claim 12, further comprising:
determining a file format of the case update information;
converting the case update information into a machine-readable text format; and
determining the identifying data of the case update information based on the machine-readable text format.

15. The method of claim 12, wherein:
the case file further includes retainer data, wherein the retainer data comprises one or more of: a client name, a tort type, a litigating status, client contact data, or a case identifier; and
the creating and storing the case record for each case file further includes storing the retainer data in the case record.

16. The method of claim 15, wherein the categorizing the received case update information with the identified at least one case record, including determining the status of the case record further comprises:
updating one or more of the client name, the tort type, the litigating status, the client contact data, or the case identifier in the case file.

17. A non-transitory machine-readable medium having executable instructions to cause one or more processing units to perform a method for operating a case management system, the case management system comprising a portal and a user interface, and the method comprising:
receiving an initial plurality of case files, each of the case files including identifying data and one or more permitted users associated with one or more of the case files;
creating and storing a case record for each case file, including the identifying data and permitted users;
receiving a case update information related to the case file from one or more of the permitted users;
identifying the case update information with at least one case record based on a selected certainty of an association of the identifying data included with the case update information;
categorizing the received case update information with the identified at least one case record, including determining a status of the case record; and
receiving a user input of a selection one or more parameters relating to one or more case records for compiling a customized case analysis.

18. The non-transitory machine-readable medium of claim 17, wherein the case management system further comprises a user interface, the user interface comprises a graphical or web-based interface, and the method further comprises:
enable visual navigation of the one or more case records on the user interface; and
display of the one or more selected case records of the customized case analysis.

19. The non-transitory machine-readable medium of claim 17, wherein:
the case file further includes retainer data, wherein the retainer data comprises one or more of: a client name, a tort type, a litigating status, client contact data, or a case identifier; and
the creating and storing the case record for each case file further includes storing the retainer data in the case record.

20. The non-transitory machine-readable medium of claim 19, wherein the categorizing the received case update information with the identified at least one case record, including determining the status of the case record further comprises:
updating one or more of the client name, the tort type, the litigating status, the client contact data, or the case identifier in the case file.
